(19) United States
(12) Patent Application Publication
(10) Pub. No.: US 2024/0310206 A1
(43) Pub. Date: Sep. 19, 2024

(54) QUICKSAND AMOUNT OBSERVATION SYSTEM, QUICKSAND AMOUNT OBSERVATION APPARATUS, QUICKSAND AMOUNT OBSERVATION METHOD, AND COMPUTER-READABLE MEDIUM

(71) Applicant: NEC Corporation, Minato-ku, Tokyo (JP)

(72) Inventor: Hiroaki KOSHIO, Tokyo (JP)

(73) Assignee: NEC Corporation, Minato-ku, Tokyo (JP)

(21) Appl. No.: 18/575,405

(22) PCT Filed: Jul. 13, 2021
(86) PCT No.: PCT/JP2021/026258

§ 371 Date: Dec. 29, 2023

(51) Int. Cl. G01H 9/00

(52) U.S. Cl. CPC G01H 9/004

(57) ABSTRACT

A quicksand amount observation system according to the present disclosure includes: a metal tube (10A) laid in a river; an optical fiber cable (20A) that is passed through the metal tube (10); a communication unit (31A) configured to emit a light pulse to the optical fiber cable (20A) and receive, from the optical fiber cable (20A), a back-scattered light generated when the emitted light pulse is transmitted; a detection unit (32A) configured to detect a hitting sound generated by hitting of quicksand against the metal tube (10A) on the basis of a change in characteristics of the back-scattered light received by the communication unit (31A); and a quicksand amount calculation unit (41A) configured to calculate a quicksand amount on the basis of characteristics of the hitting sound detected by the detection unit (32A).

### TECHNICAL FIELD

The present disclosure relates to a quicksand amount observation system, a quicksand amount observation apparatus, a quicksand amount observation method, and a computer-readable medium.

### BACKGROUND ART

Quicksand amount is one of the important items for grasping the characteristics of rivers. Results of observation of quicksand amounts are used for river disaster prevention planning and river conservation planning.

Hydrophones have been used to observe quicksand amounts in a quicksand amount observation system of a related technology. Specifically, a hydrophone is placed in a metal tube and a hitting sound generated when quicksand hits against the metal tube is measured using the hydrophone, and a quicksand amount is calculated from the measured hitting sound.

However, in a case where a quicksand amount observation system using a hydrophone continuously observes a wide area of a river basin, there is a problem that securing and maintaining many hydrophones, power sources, communication facilities, etc. is costly, and there is also a problem of a risk of damage due to lightning, etc.

Therefore, recently, a technique for observing a quicksand amount without having to use a hydrophone has been proposed.

For example, Patent Literature 1 discloses a technique of forming an FBG sensor by bonding an FBG (Fiber Bragg Grating) optical fiber to the inside of a tube, measuring the amount of strain of the tube due to hitting of quicksand against the tube from an optical signal of Bragg wavelength output from the FBG sensor, and calculating the quicksand amount from the measured amount of strain.

### CITATION LIST

### Patent Literature

Patent Literature 1: Japanese Unexamined Patent Application Publication No. 2010-276343

### SUMMARY OF INVENTION

### Technical Problem

The technology disclosed in the above-mentioned Patent Literature 1 measures the strain generated in a tube due to hitting of quicksand against the tube.

When the strain of the tube is measured, the measured strain corresponds to the strain of the tube where the tube and the optical fiber are bonded.

Therefore, it is necessary to consider the direction of hitting of quicksand against a tube when installing the tube. However, it is difficult to grasp the direction of hitting beforehand because there is a variation in the direction in which quicksand moves.

On the other hand, when measuring a hitting sound generated when quicksand hits against a tube, it is not necessary to consider the direction of hitting. Therefore, it is effective to focus on the sound of hitting of quicksand on a tube in performing observation of a quicksand amount.

This has recently led to increasing demands for techniques by which a quicksand amount can be observed from a sound of hitting of quicksand against a tube without having to use a hydrophone.

Therefore, an object of the present disclosure is to solve the above-mentioned problem and to provide a quicksand amount observation system, a quicksand amount observation apparatus, a quicksand amount observation method, and a computer-readable medium each adapted to observe a quicksand amount from a sound of hitting of quicksand against a tube without having to use of a hydrophone.

### Solution to Problem

According to an aspect of the present disclosure, a quicksand amount observation system includes:
a metal tube laid in a river;
an optical fiber cable that is passed through the metal tube;
a communication unit configured to emit a light pulse to the optical fiber cable and receive, from the optical fiber cable, a back-scattered light generated when the emitted light pulse is transmitted;
a detection unit configured to detect a hitting sound generated by hitting of quicksand against the metal tube on the basis of a change in characteristics of the back-scattered light received by the communication unit; and a quicksand amount calculation unit configured to calculate a quicksand amount on the basis of characteristics of the hitting sound detected by the detection unit.

According to an aspect of the present disclosure, a quicksand amount observation apparatus includes:
a detection unit configured to detect a hitting sound generated by hitting of quicksand against a metal tube on the basis of a change in characteristics of a back-scattered light received from an optical fiber cable that is passed through the metal tube laid in a river; and a quicksand amount calculation unit configured to acquire a result of the detection of the hitting sound from the detection unit and to calculate a quicksand amount on the basis of characteristics of the hitting sound detected by the detection unit.

According to an aspect of the present disclosure, a quicksand amount observation method implemented by a quicksand amount observation apparatus, includes:
a step of detecting a hitting sound generated by hitting of quicksand against a metal tube on the basis of a change in characteristics of a back-scattered light received from an optical fiber cable that is passed through the metal tube laid in a river by a detection unit and acquiring a result of the detection of the hitting sound from the detection unit; and a step of calculating a quicksand amount on the basis of characteristics of the hitting sound detected by the detection unit.

According to an aspect of the present disclosure, a non-transitory computer-readable medium stores a program for causing a computer to execute the processes of:
detecting a hitting sound generated by hitting of quicksand against a metal tube on the basis of a change in characteristics of a back-scattered light received from an optical fiber cable that is passed through the metal tube laid in a river by a detection unit and acquiring a result of the detection of the hitting sound from the detection unit; and calculating a quicksand amount on the basis of characteristics of the hitting sound detected by the detection unit.

### Advantageous Effects of Invention

According to the above-described aspect, it is possible to provide a quicksand amount observation system, a quicksand amount observation apparatus, and a quicksand amount observation method each adapted to observe a quicksand amount from a sound of hitting of quicksand against a tube without having to use a hydrophone.

### BRIEF DESCRIPTION OF DRAWINGS

FIG. 1 is a diagram showing a configuration example of a quicksand amount observation system according to a first example embodiment;

FIG. 2 is an image diagram showing an operation example in which a communication unit according to the first example embodiment emits a light pulse and receives a back-scattered light;

FIG. 3 is an image diagram showing an example of a correspondence relationship between a quicksand amount and a sound pressure of a sound of hitting of quicksand against a tube;

FIG. 4 is a flow diagram showing an example of a schematic operation flow of a quicksand amount observation system according to the first example embodiment;

FIG. 5 is a diagram showing an example of a configuration of a quicksand amount observation system according to a second example embodiment; and

FIG. 6 is a block diagram showing an example of a hardware configuration of a computer implementing the quicksand amount observation apparatus according to the first and second example embodiments.

### EXAMPLE EMBODIMENT

Example embodiments of the present disclosure will be described below with reference to the drawings. The following descriptions and drawings have been omitted and simplified as appropriate for clarity of the explanation. In the following drawings, the same elements are denoted by the same reference symbols, and duplicate explanations thereof have been omitted as where necessary.

### First Example Embodiment

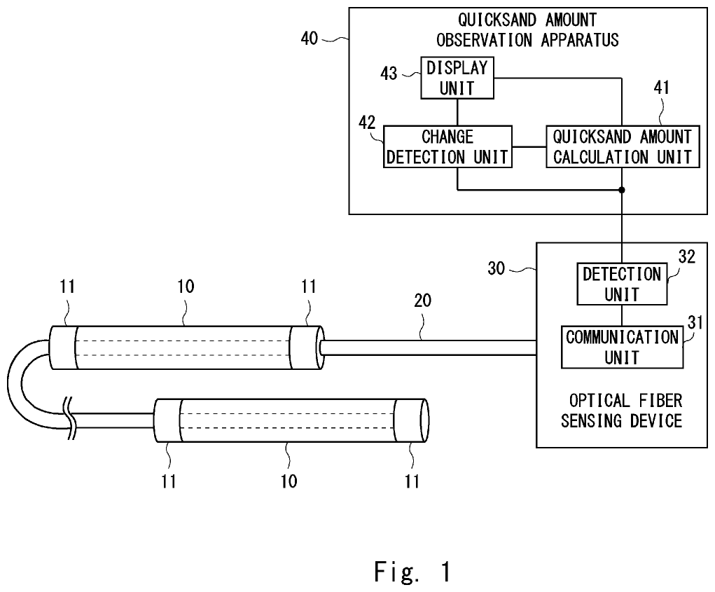

FIG. 1 is a diagram showing a configuration example of a quicksand amount observation system according to a first example embodiment.

As shown in FIG. 1, the quicksand amount observation system according to the first example embodiment includes a metal tube 10, an optical fiber cable 20, an optical fiber sensing device 30, and a quicksand amount observation apparatus 40.

The metal tube 10 is laid in a river.

The optical fiber cable 20 is passed through the metal tube 10 and one end of the optical fiber cable 20 is connected to the optical fiber sensing device 30. The optical fiber cable 20 that is passed through the metal tube 10 and the optical fiber cable 20 that is passed outside the metal tube 10 are connected through a connector 11.

The optical fiber sensing device 30 includes a communication unit 31 and a detection unit 32.

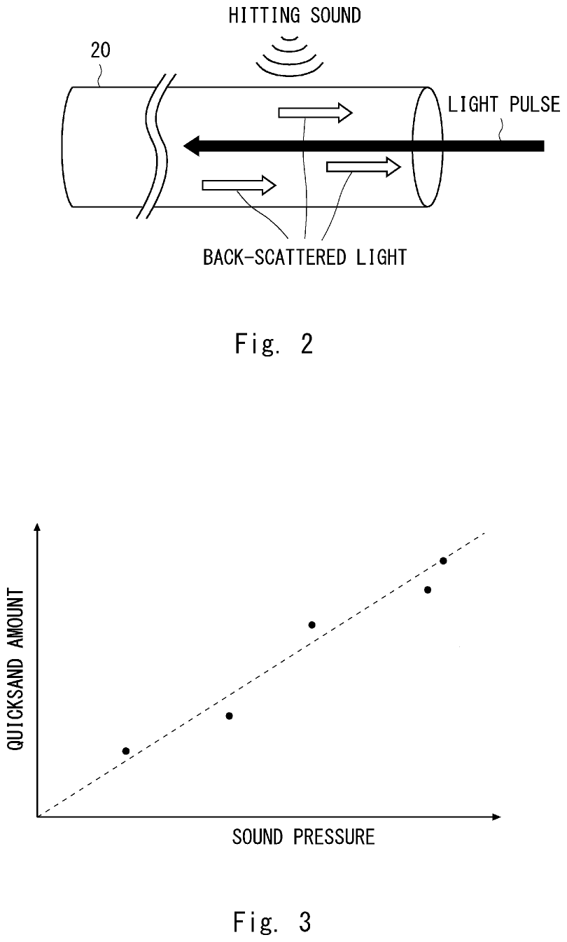

The communication unit 31 emits a light pulse to the optical fiber cable 20 and receives, from the optical fiber cable 20, a back-scattered light generated when the emitted light pulse is transmitted through the optical fiber cable 20. FIG. 2 is an image diagram showing an operation example in which the communication unit 31 emits a light pulse and receives a back-scattered light.

When a sound wave, which is generated when quicksand hits against the metal tube 10, is applied to the optical fiber cable 20, the characteristics (e.g., wavelength) of the back-scattered light changes. Therefore, the detection unit 32 detects a sound of hitting of quicksand against a tube (hereinafter referred to as a hitting sound) on the basis of the change in the characteristics of the back-scattered light received by the communication unit 31.

At the same time, the detection unit 32 identifies the position on the optical fiber cable 20 (i.e., the distance from the optical fiber sensing device 30) where the hitting sound is generated on the basis of the time difference between the emission time of the light pulse from the communication unit 31 to the optical fiber cable 20 and the reception time of the back-scattered light from the optical fiber cable 20 by the communication unit 31.

The communication unit 31 and the detection unit 32 can be implemented by, for example, DAS (Distributed Acoustic Sensor). The hitting sound detected by the detection unit 32 and information on the position on the optical fiber cable where the hitting sound was generated (hereinafter referred to as a generation position) identified by the detection unit 32 are processed by the quicksand amount observation apparatus 40 in the subsequent stage.

The quicksand amount observation apparatus 40 includes a quicksand amount calculation unit 41, a change detection unit 42, and a display unit 43.

The quicksand amount calculation unit 41 calculates a quicksand amount on the basis of a preset correspondence relationship between a quicksand amount and a sound pressure of a hitting sound, and the sound pressure of the hitting sound detected by the detection unit 32.

The above-mentioned correspondence relationship may be derived from the observation results obtained by observing a hitting sound in an environment in which the quicksand amount is controlled. For example, a plurality of pairs of a quicksand amount and a sound pressure of a hitting sound may be observed, and assuming that the quicksand amount and the sound pressure of the hitting sound exhibit a linear relationship, the best fitting straight-line relationship may be derived as a correspondence relationship. FIG. 3 is an image diagram showing an example of the correspondence relationship between a quicksand amount and a sound pressure of a hitting sound. In FIG. 3, each black dot represents observation data of a pair of a quicksand amount and a sound pressure of a hitting sound, and the dotted line represents the correspondence relationship derived on the basis of the observation data.

The change detection unit 42, in which the normal range of the sound pressure of the hitting sound or the normal range of the quicksand amount are preset, detects that there is a change in the conditions of the river basin when the sound pressure of the hitting sound detected by the detection unit 32 or the quicksand amount calculated by the quicksand amount calculation unit 41 deviates from the normal range.

The display unit 43 displays the quicksand amount at the generation position of the hitting sound and displays the detection status of the change in the conditions of the river basin at the generation position of the hitting sound. For example, the display unit 43 may display, on a map, the quicksand amount at the generation position of the hitting sound and the detection status of the change in the conditions of the river basin at the generating position of the hitting sound by associating the location on the map with the generating position of the hitting sound.

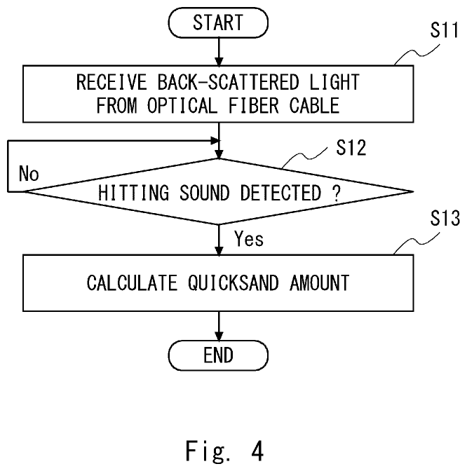

Next, the operation of the quicksand amount observation system according to the first example embodiment will be described. FIG. 4 is a flow diagram showing an example of a schematic operation flow of the quicksand amount observation system according to the first example embodiment.

As shown in FIG. 4, the communication unit 31 emits a light pulse to the optical fiber cable 20 and receives, from the optical fiber cable 20, a back-scattered light generated when the emitted light pulse is transmitted (Step S11).

The detection unit 32 detects a hitting sound generated by hitting of quicksand against the metal tube 10 on the basis of the change in the characteristics of the back-scattered light received by the communication unit 31 (Step S12).

When the hitting sound is detected by the detection unit 32 (Yes in Step S12), the quicksand amount calculation unit 41 calculates the quicksand amount on the basis of the preset correspondence relationship between a quicksand amount and a sound pressure of a hitting sound, and the sound pressure of the hitting sound detected by the detection unit 32 (Step S13).

The detection unit 32 may identify the position on the optical fiber cable 20 where the hitting sound is generated on the basis of the time difference between the emission time of the light pulse and the reception time of the back-scattered light.

When the sound pressure of the hitting sound or the quicksand amount deviates from the normal range, the change detection unit 42 may detect that there is a change in the conditions of the river basin.

The display unit 43 may display the detection status of the change in the conditions of the river basin at the generation position of the hitting sound, while displaying the quicksand amount at the generation position of the hitting sound.

As described above, according to the first example embodiment, the communication unit 31 emits a light pulse to the optical fiber cable 20 and receives, from the optical fiber cable 20, a back-scattered light generated when the emitted light pulse is transmitted. The detection unit 32 detects a hitting sound generated by hitting of quicksand against the metal tube 10 on the basis of the change in the characteristics of the back-scattered light received by the communication unit 31. The quicksand amount calculation unit 41 calculates the quicksand amount on the basis of the preset correspondence relationship between a quicksand amount and a sound pressure of a hitting sound, and the sound pressure of the hitting sound detected by the detection unit 32. As a result, a quicksand amount can be observed from a hitting sound of quicksand against the metal tube 10 without having to use a hydrophone.

According to the first example embodiment, the optical fiber cable 20, which does not require a power supply, is used instead of a hydrophone. As a result, it is possible to achieve effects such as being able to observe a quicksand amount even in an environment where there is no power supply or communication facilities and an excellent environmental resistance.

In addition, according to the first example embodiment, the detection unit 32 may identify the position on the optical fiber cable 20 where the hitting sound is generated on the basis of the time difference between the emission time of the light pulse from the communication unit 31 to the optical fiber cable 20 and the reception time of the back-scattered light from the optical fiber cable 20 by the communication unit 31. As a result, it is possible to achieve an effect that distribution data of the quicksand amount along the optical fiber cable 20 can be obtained.

According to the first example embodiment, when the sound pressure of the hitting sound detected by the detection unit 32 or the quicksand amount calculated by the quicksand amount calculation unit 41 deviates from the normal range, the change detection unit 42 may detect that there is a change in the conditions of the river basin. Thus, the first example embodiment can be used for detecting a change in the conditions of the river basin due to mountain collapse or development progress of the river basin.

In the first example embodiment, the correspondence relationship between the quicksand amount and the sound pressure of the hitting sound used in the quicksand amount calculation unit 41 is derived by fitting a straight line, but it is not limited thereto. For example, the correspondence relationship between a quicksand amount and a sound pressure of a hitting sound may be derived using any mathematical model.

The quicksand amount calculation unit 41 used, but not limited thereto, a sound pressure as a characteristic of a hitting sound when calculating a quicksand amount. For example, the quicksand amount calculation unit 41 may use a number of pulses or frequency characteristics as a characteristic of a hitting sound when calculating a quicksand amount.

### Second Example Embodiment

FIG. 5 is a diagram showing a configuration example of a quicksand amount observation system according to a second example embodiment. The second example embodiment corresponds to an example embodiment which is generic concept of the first example embodiment described above.

As shown in FIG. 5, the quicksand amount observation system according to the second example embodiment includes a metal tube 10A, an optical fiber cable 20A, an optical fiber sensing device 30A, and a quicksand amount observation apparatus 40A.

The metal tube 10A is laid in a river.

The optical fiber cable 20A passes through the metal tube 10 and one end of the optical fiber cable 20A is connected to the optical fiber sensing device 30.

The optical fiber sensing device 30A includes a communication unit 31A and a detection unit 32A.

The communication unit 31A emits a light pulse to the optical fiber cable 20A and receives, from the optical fiber cable 20A, a back-scattered light generated when the emitted light pulse is transmitted.

The detection unit 32A detects a hitting sound generated by hitting of quicksand against the metal tube 10A on the basis of the change in the characteristics (e.g., wavelength) of the back-scattered light received by the communication unit 31A.

The quicksand amount observation apparatus 40A includes a quicksand amount calculation unit 41A.

The quicksand amount calculation unit 41A acquires the detection result of the hitting sound from the detection unit 32A. The quicksand amount calculation unit 41A calculates the quicksand amount on the basis of the characteristics of the hitting sound detected by the detection unit 32A.

Thus, according to the second example embodiment, it is possible to observe a quicksand amount from the hitting sound of quicksand against the metal tube 10A without having to use a hydrophone.

It should be noted that the quicksand amount calculation unit 41A may calculate a quicksand amount on the basis of the preset correspondence relationship between a quicksand amount and a sound pressure of a hitting sound, and the sound pressure of the hitting sound detected by the detection unit 32A.

The detection unit 32A may identify the position on the optical fiber cable 20A where the hitting sound is generated on the basis of the time difference between the emission time of the light pulse from the communication unit 31A to the optical fiber cable 20A and the reception time of the back-scattered light from the optical fiber cable 20A by the communication unit 31A. The quicksand amount calculation unit 41A may also acquire, from the detection unit 32A, information on the position on the optical fiber cable 20 where a hitting sound detected by the detection unit 32A was generated.

The quicksand amount observation apparatus 40A may further include a change detection unit. The change detection unit, in which the normal range of the sound pressure of the hitting sound or the normal range of the quicksand amount is preset, and may detect that there is a change in the conditions of the river basin when the sound pressure of the hitting sound detected by the detection unit 32A or the quicksand amount calculated by the quicksand amount calculation unit 41A deviates from the normal range.

The quicksand amount observation apparatus 40A may further include a display unit. The display unit may display the quicksand amount at the generation position of the hitting sound detected by the detection unit 32A and may also display the detection status of the change in the conditions of the river basin at the generation position of the hitting sound detected by the detection unit 32A.

### <Hardware Configuration of Quicksand Amount Observation Apparatus According to First and Second Example Embodiments >

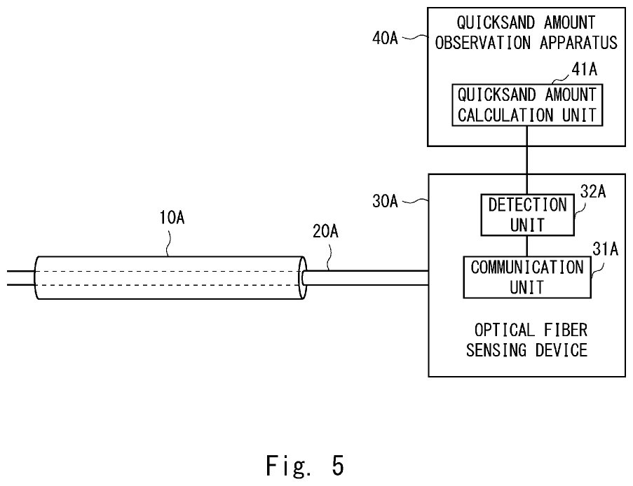

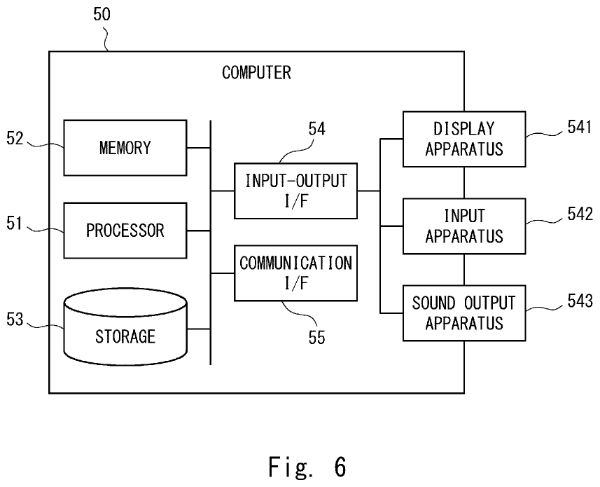

FIG. 6 is a diagram showing a hardware configuration example of a computer 50 implementing the quicksand amount observation apparatuses 40 and 40A according to the first and second example embodiments described above.

As shown in FIG. 6, the computer 50 includes a processor 51, a memory 52, a storage 53, an input-output interface (I/F) 54, a communication interface (I/F) 55, and the like. The processor 51, the memory 52, the storage 53, the input-output interface 54, and the communication interface 55 are connected to one another via a data transmission path for transmitting and receiving data to and from each other.

The processor 51 is, for example, a processing unit such as a CPU (Central Processing Unit) or a GPU (Graphics Processing Unit). The memory 52 is, for example, a memory such as a RAM (Random Access Memory) or a ROM (Read Only Memory). The storage 53 is, for example, a storage device such as an HDD (Hard Disk Drive), an SSD (Solid State Drive), or a memory card. The storage 53 may also be a memory such as a RAM or a ROM.

The storage 53 stores programs that implement the functions of the structural components of the quicksand amount observation apparatuses 40 and 40A. The processor 51 implements the functions of the structural components of the quicksand amount observation apparatus 40 by executing these programs. Here, when executing the programs, the processor 51 may read these programs into the memory 52 before executing them, or may execute them without reading them into the memory 52. The memory 52 and the storage 53 also serve to store information and data held by the structural components of the quicksand amount observation apparatuses 40 and 40A.

The above-mentioned program may also be stored in a non-transitory computer-readable medium or a tangible storage medium. By way of example, but not limitation thereto, a computer-readable medium or a tangible storage medium may include a RAM, a ROM, a flash memory, SSD, or other memory technology, CD-ROM (Compact Disc-ROM), DVD (Digital Versatile Disc), Blu-ray (registered trademark) disc, or other optical disc storage, magnetic cassette, magnetic tape, magnetic disc storage, or other magnetic storage devices. The program may be transmitted on a temporary computer-readable medium or a communication medium. By way of example, but not limited thereto, a temporary computer-readable medium or a communication medium may include an electrical, optical, acoustic, or other form of propagating signals.

An input-output interface 54 is connected to a display apparatus 541, an input apparatus 542, a sound output apparatus 543, and the like. The display apparatus 541 displays a screen corresponding to drawing data processed by the processor 51, such as an LCD (Liquid Crystal Display), a CRT (Cathode Ray Tube) display, or a monitor. The input apparatus 542 is an apparatus for receiving an operational input by an operator, such as a keyboard, a mouse, and a touch sensor. The display apparatus 541 and the input apparatus 542 may be integrated and implemented as a touch panel. The sound output apparatus 543 is an apparatus such as a speaker that acoustically outputs sound corresponding to acoustic data processed by the processor 51.

The communication interface 55 transmits and receives data to and from an external apparatus. For example, the communication interface 55 communicates with an external apparatus via a wired or wireless communication channel.

The optical fiber sensing devices 30 and 30A according to the first and second example embodiment described above can also be implemented by a computer, and the computer implementing the optical fiber sensing devices 30 and 30A may also have the hardware configuration shown in FIG. 6.

Although the present disclosure has been described with reference to the example embodiments, the present disclosure is not limited to the example embodiments described above. Various changes in the configuration and details of the present disclosure may be made within the scope of the present disclosure that may be understood by a person skilled in the art.

In addition, a part or all of the above example embodiments may also be described as in the following supplementary notes, but not limited to the following.

### Supplementary Note 1

A quicksand amount observation system comprising:
a metal tube laid in a river;
an optical fiber cable that is passed through the metal tube;
a communication unit configured to emit a light pulse to the optical fiber cable and receive, from the optical fiber cable, a back-scattered light generated when the emitted light pulse is transmitted;
a detection unit configured to detect a hitting sound generated by hitting of quicksand against the metal tube on the basis of a change in characteristics of the back-scattered light received by the communication unit; and a quicksand amount calculation unit configured to calculate a quicksand amount on the basis of characteristics of the hitting sound detected by the detection unit.

### Supplementary Note 2

The quicksand amount observation system according to supplementary note 1, wherein the quicksand amount calculation unit is configured to calculate the quicksand amount on the basis of a preset correspondence relationship between a quicksand amount and a sound pressure of a hitting sound, and the sound pressure of the hitting sound detected by the detection unit.

### Supplementary Note 3

The quicksand amount observation system according to supplementary note 2, wherein the detection unit is configured to identify a position on the optical fiber cable where the hitting sound is generated on the basis of the time difference between an emission time of the light pulse from the communication unit to the optical fiber cable and a reception time of a back-scattered light from the optical fiber cable by the communication unit.

### Supplementary Note 4

The quicksand amount observation system according to supplementary note 3, further comprising a change detection unit, in which a normal range of a sound pressure of a hitting sound or a normal range of a quicksand amount is preset, configured to detect that there is a change in conditions of the river basin when the sound pressure of the hitting sound detected by the detection unit or the quicksand amount calculated by the quicksand amount calculation unit deviates from the normal range.

### Supplementary Note 5

The quicksand amount observation system according to supplementary note 4, further comprising a display unit configured to display the detection status of a change in a river basin status at the generating position of the hitting sound detected by the detection unit while displaying a quicksand amount at the generating position of the hitting sound detected by the detection unit.

### Supplementary Note 6

A quicksand amount observation apparatus comprising:
a quicksand amount calculation unit configured to acquire a result of detection of a hitting sound generated by hitting of quicksand against a metal tube laid in a river from a detection unit and to calculate a quicksand amount on the basis of characteristics of the hitting sound detected by the detection unit, wherein the detection unit is configured to detect the hitting sound on the basis of a change in characteristics of a back-scattered light received from an optical fiber cable that is passed through the metal tube.

### Supplementary Note 7

The quicksand amount observation apparatus according to supplementary note 6, wherein the quicksand amount calculation unit is configured to calculate the quicksand amount on the basis of a preset correspondence relationship between a quicksand amount and a sound pressure of a hitting sound, and the sound pressure of the hitting sound detected by the detection unit.

### Supplementary Note 8

The quicksand amount observation apparatus according to supplementary note 7, wherein the quicksand amount calculation unit is configured to acquire, from the detection unit, information on the position on the optical fiber cable where the hitting sound detected by the detection unit was generated.

### Supplementary Note 9

The quicksand amount observation apparatus according to supplementary note 8, further comprising a change detection unit, in which a normal range of a sound pressure of a hitting sound or a normal range of a quicksand amount is preset, configured to detect that there is a change in conditions of the river basin when the sound pressure of the hitting sound detected by the detection unit or the quicksand amount calculated by the quicksand amount calculation unit deviates from the normal range.

### Supplementary Note 10

The quicksand amount observation apparatus according to supplementary note 9, further comprising a display unit configured to display the detection status of a change in a river basin status at the generating position of the hitting sound detected by the detection unit while displaying a quicksand amount at the generating position of the hitting sound detected by the detection unit.

### Supplementary Note 11

A quicksand amount observation method implemented by a quicksand amount observation apparatus, the method comprising:
a step of acquiring a result of detection of a hitting sound generated by hitting of quicksand against a metal tube laid in a river from a detection unit, wherein the detection unit is configured to detect the hitting sound on the basis of a change in characteristics of a back-scattered light received from an optical fiber cable that is passed through the metal tube; and a step of calculating a quicksand amount on the basis of characteristics of the hitting sound detected by the detection unit.

### Supplementary Note 12

A non-transitory computer-readable medium storing a program for causing a computer to execute the processes of:
acquiring a result of detection of a hitting sound generated by hitting of quicksand against a metal tube laid in a river from a detection unit, wherein the detection unit is configured to detect the hitting sound on the basis of a change in characteristics of a back-scattered light received from an optical fiber cable that is passed through the metal tube; and calculating a quicksand amount on the basis of characteristics of the hitting sound detected by the detection unit.

### REFERENCE SIGNS LIST

10, 10A METAL TUBE
11 CONNECTOR
20, 20A OPTICAL FIBER CABLE
30, 30A OPTICAL FIBER SENSING DEVICE
31, 31A COMMUNICATION UNIT
32, 32A DETECTION UNIT
40, 40A QUICKSAND AMOUNT OBSERVATION APPARATUS
41, 41A QUICKSAND AMOUNT CALCULATION UNIT
42 CHANGE DETECTION UNIT
43 DISPLAY UNIT
50 COMPUTER
51 PROCESSOR
52 MEMORY
53 STORAGE
54 INPUT-OUTPUT INTERFACE
541 DISPLAY APPARATUS
542 INPUT APPARATUS
543 SOUND OUTPUT APPARATUS
55 COMMUNICATION INTERFACE

What is claimed is:

1. A quicksand amount observation system comprising:
a metal tube laid in a river;
an optical fiber cable that is passed through the metal tube;
at least one memory storing instructions, and
at least one processor configured to execute the instructions to;
emit a light pulse to the optical fiber cable and receive, from the optical fiber cable, a back-scattered light generated when the emitted light pulse is transmitted;
detect a hitting sound generated by hitting of quicksand against the metal tube on the basis of a change in characteristics of the received back-scattered light; and
calculate a quicksand amount on the basis of characteristics of the detected hitting sound.

2. The quicksand amount observation system according to claim 1, wherein the at least one processor is further configured to execute the instructions to calculate the quicksand amount on the basis of a preset correspondence relationship between a quicksand amount and a sound pressure of a hitting sound, and the sound pressure of the detected hitting sound.

3. The quicksand amount observation system according to claim 2, wherein the at least one processor is further configured to execute the instructions to identify a position on the optical fiber cable where the hitting sound is generated on the basis of the time difference between an emission time of the light pulse to the optical fiber cable and a reception time of a back-scattered light from the optical fiber cable.

4. The quicksand amount observation system according to claim 3, wherein the at least one processor, in which a normal range of a sound pressure of a hitting sound or a normal range of a quicksand amount is preset, is further configured to execute the instructions to detect that there is a change in conditions of the river basin when the sound pressure of the detected hitting sound or the calculated quicksand amount deviates from the normal range.

5. The quicksand amount observation system according to claim 4, further comprising a display unit configured to display the detection status of a change in a river basin status at the generating position of the detected hitting sound while displaying a quicksand amount at the generating position of the detected hitting sound.

6. A quicksand amount observation apparatus comprising:
at least one memory storing instructions, and
at least one processor configured to execute the instructions to;
acquire a result of detection of a hitting sound generated by hitting of quicksand against a metal tube laid in a river from a detection unit and to calculate a quicksand amount on the basis of characteristics of the hitting sound detected by the detection unit, wherein the detection unit is configured to detect the hitting sound on the basis of a change in characteristics of a back-scattered light received from an optical fiber cable that is passed through the metal tube.

7. The quicksand amount observation apparatus according to claim 6, wherein the at least one processor is further configured to execute the instructions to calculate the quicksand amount on the basis of a preset correspondence relationship between a quicksand amount and a sound pressure of a hitting sound, and the sound pressure of the hitting sound detected by the detection unit.

8. The quicksand amount observation apparatus according to claim 7, wherein the at least one processor is further configured to execute the instructions to acquire, from the detection unit, information on the position on the optical fiber cable where the hitting sound detected by the detection unit was generated.

9. The quicksand amount observation apparatus according to claim 8, wherein the at least one processor, in which a normal range of a sound pressure of a hitting sound or a normal range of a quicksand amount is preset, is further configured to execute the instructions to detect that there is a change in conditions of the river basin when the sound pressure of the hitting sound detected by the detection unit or the calculated quicksand amount deviates from the normal range.

10. The quicksand amount observation apparatus according to claim 9, further comprising a display unit configured to display the detection status of a change in a river basin status at the generating position of the hitting sound detected by the detection unit while displaying a quicksand amount at the generating position of the hitting sound detected by the detection unit.

11. A quicksand amount observation method implemented by a quicksand amount observation apparatus, the method comprising:
a step of acquiring a result of detection of a hitting sound generated by hitting of quicksand against a metal tube laid in a river from a detection unit, wherein the detection unit is configured to detect the hitting sound on the basis of a change in characteristics of a back-scattered light received from an optical fiber cable that is passed through the metal tube; and
a step of calculating a quicksand amount on the basis of characteristics of the hitting sound detected by the detection unit.

12. (canceled)
